(19) United States
(12) Patent Application Publication
(10) Pub. No.: US 2005/0127657 A1
(43) Pub. Date: Jun. 16, 2005

(54) Quick-release mechanism for an electric cart

(75) Inventor: Donald P.H. Wu, Hsin-Chu County (TW)

Correspondence Address: CHARLES E. BAXLEY, ESQ., 90 JOHN STREET, THIRD FLOOR, NEW YORK, NY, 10038, US

(73) Assignee: Pihsiang Machinery Co., Ltd.

(21) Appl. No.: 10/979,684

(22) Filed: Nov. 2, 2004

(30) Foreign Application Priority Data
Dec. 3, 2003 (TW) 092221266

(51) Int. Cl. B62D 21/12

(52) U.S. Cl. 280/781

(57) ABSTRACT

A quick-release mechanism for an electric cart comprising: a rear frame, at both sides of a front edge of the rear frame is formed a locking slot, respectively; An upright column stands on the front edge of the rear frame and is located between the locking slots, the upright column provided with a locking portion, a gap is formed on the locking portion, the locking portion is further provided with a moveable hook, an end of which is installed in the gap of the locking portion, and another end of the moveable hook is located outside the gap of the locking portion; a front frame is provided at its rear edge with a cross bar, on the cross bar is provided an upright bar, both ends of the cross bar are locked in the locking slots at both sides of the rear frame, the upright bar is locked in the gap of the locking portion by the hook.

### BACKGROUND OF THE INVENTION

1. Field of the Invention

The present invention relates to an electric cart, and more particularly to a quick-release mechanism for an electric cart.

2. Description of the Prior Arts

To save installation space and make transportation easier, the frame of many electric carts is designed to be disassembleable. For example, the frame of the electric cart can be loaded into a car easily after being disassembled. So far, most of the electric carts are designed to have a front frame and a rear frame, wherein the front frame is connected to the rear frame simply by an inserting shaft. However, after being connected together, the front frame and the rear frame will rotate relative to the inserting shaft. Thereby, the electric cart will not be able to move stably.

The present invention has arisen to mitigate and/or obviate the afore-described disadvantages.

### SUMMARY OF THE INVENTION

The primary objective of the present invention is to provide a quick-release mechanism for an electric cart capable of enabling the front frame and the rear frame of an electric cart to be jointed firmly and stably, meanwhile, the front the front frame and the rear frame also can be disengaged from each other quickly and easily.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective view of an electric cart in accordance with the present invention;

FIG. 2 is an exploded view of the electric cart in accordance with the present invention;

FIG. 3 is a side view of the electric cart in accordance with the present invention;

FIG. 4 is an enlarged view of a portion of the electric cart in accordance with the present invention;

FIG. 5 is top plan view of the electric cart in accordance with the present invention;

FIG. 6 is a side view of the electric cart in accordance with the present invention, wherein the front and the rear frames are disconnected;

FIG. 7 is a side view of the electric cart in accordance with the present invention, wherein the front and the rear frames are being connected;

FIG. 8 is a top plan view of the electric cart in accordance with the present invention, wherein the front and the rear frames are connected.

### DETAILED DESCRIPTION OF THE PREFERRED EMBODIMENT

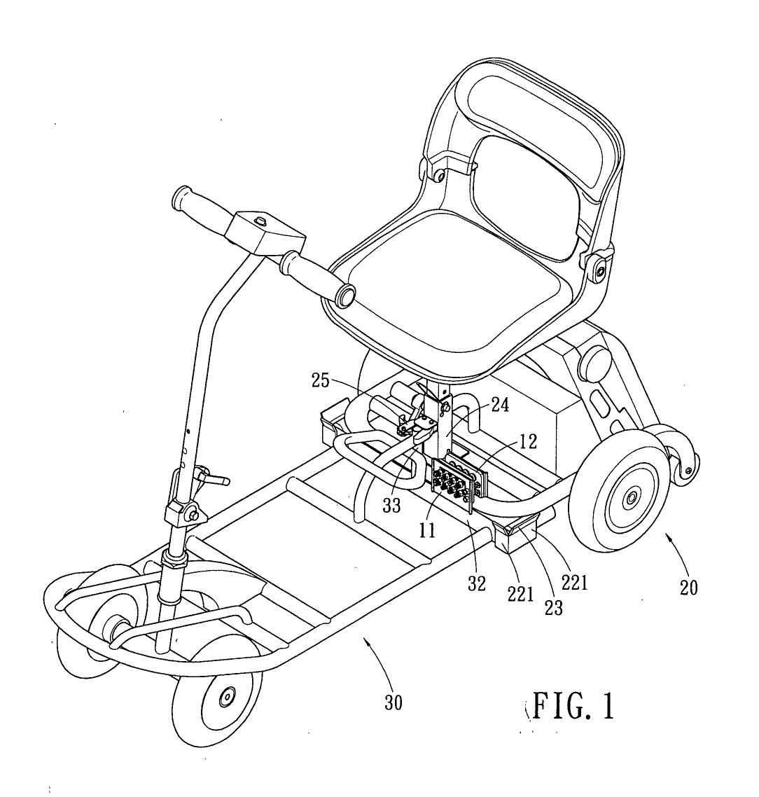

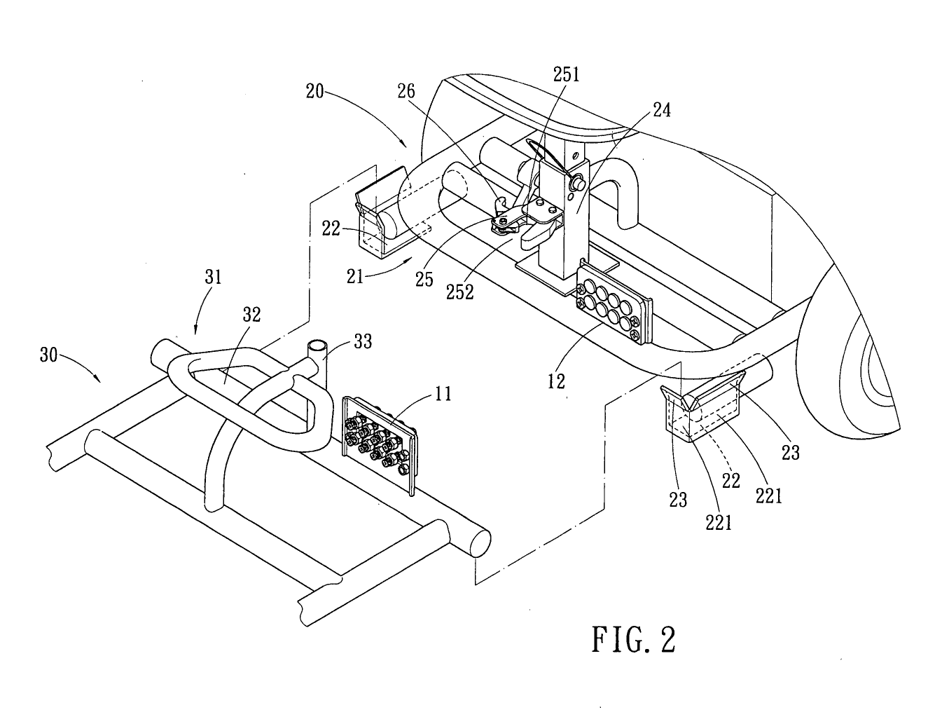

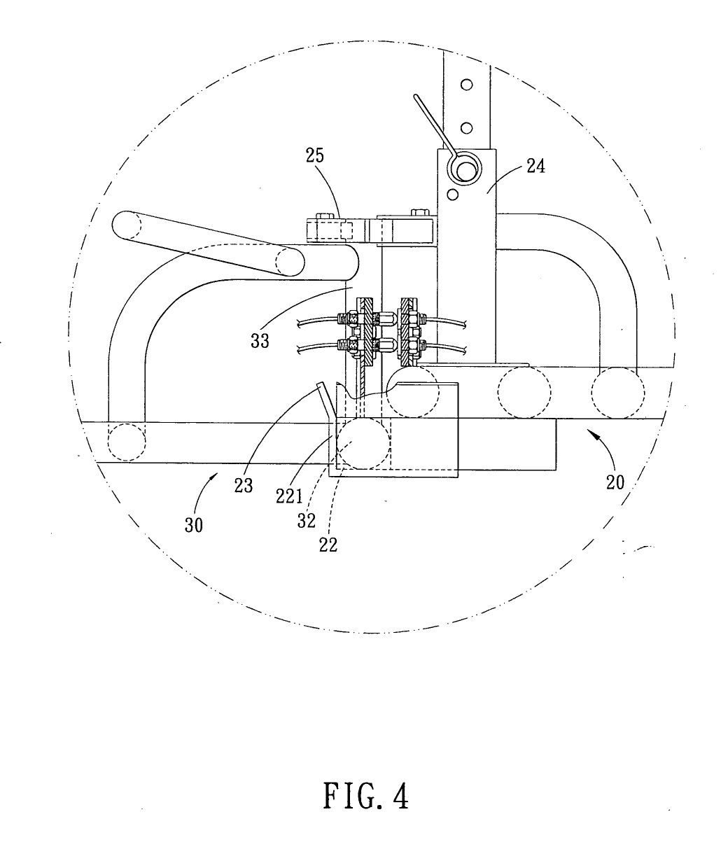

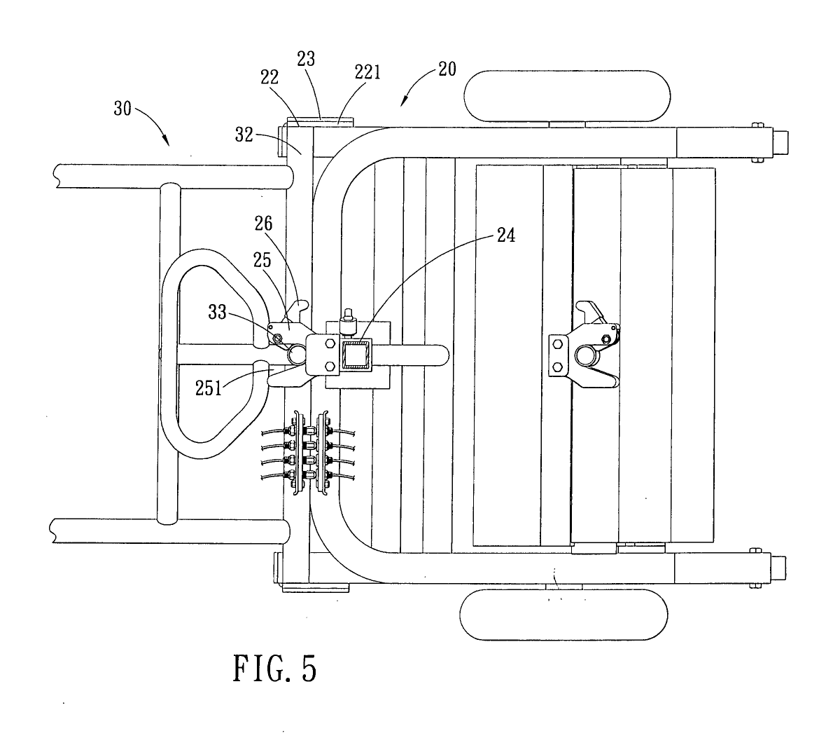

Referring to FIGS. 1-5, a quick-release mechanism for an electric cart in accordance with the present invention is shown and generally includes a front frame 20 and a rear frame 30, on the front and rear frames 20, 30 are provided a female connector 12 and a male connector 11, respectively.

The rear frame 20 is made up of a plurality of rods, at both sides of the front edge 21 of the rear frame 20 is provided a locking slot 22 which is formed by a plurality of plates 221. A guide plate 23 is slantwise disposed at the upper edge of the locking slot 22, an upright column 24 stands at the center of the front edge 21 of the rear frame 20 and is located between the two locking slots 22. The upright column 24 is provided with a locking portion 25 extending ahead of the front edge 21. On the locking portion 25 is formed a gap 251 whose mouth 252 faces the same direction as the front edge 21 of the frame 20. The locking portion 25 is further provided with a moveable hook 26 an end of which is installed in the gap 251, and another end of the moveable hook 26 is located outside the gap 251.

The front frame 30 is made up of a plurality of rods and provided at its rear edge 31 with a cross bar 32. At the center of the cross bar 32 is provided an upright bar 33. Both ends of the cross bar 32 are locked in the locking slots 22 at both sides of the rear frame 20, while the upright bar 33 is locked in the gap 251 of the locking portion 25 by the hook 26.

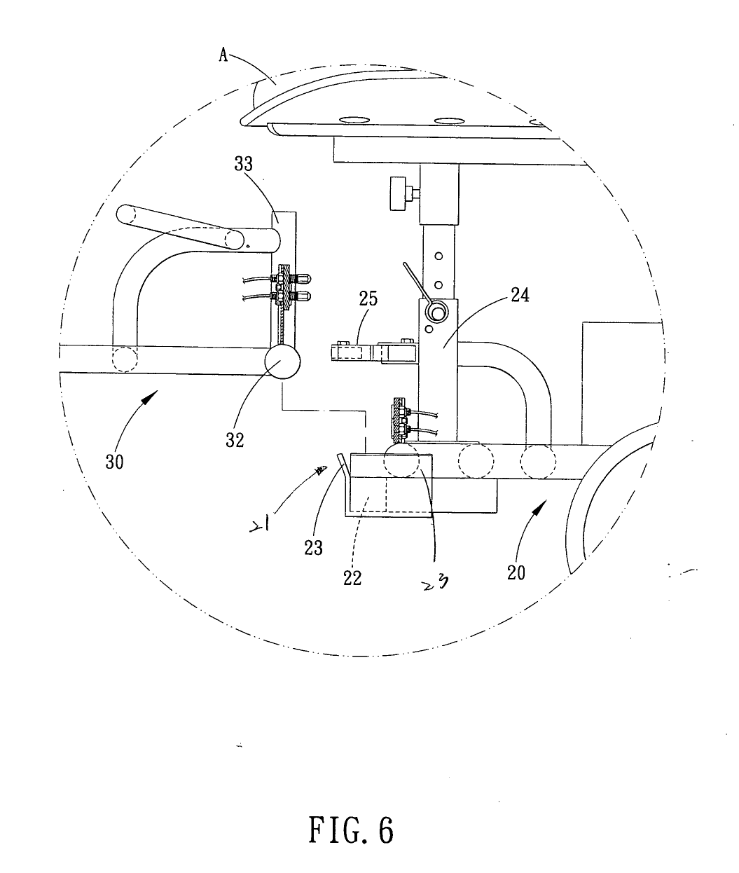

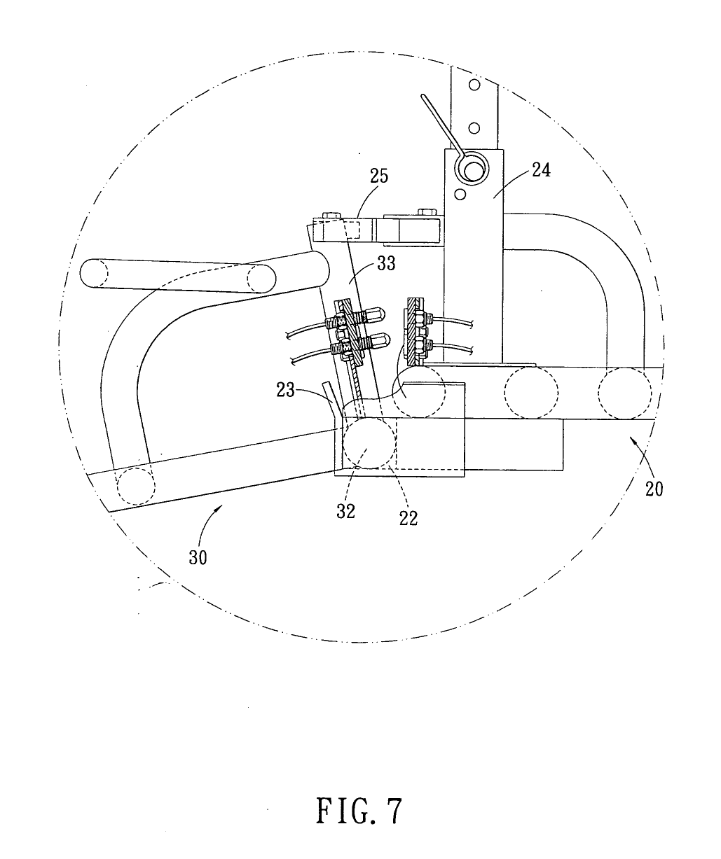

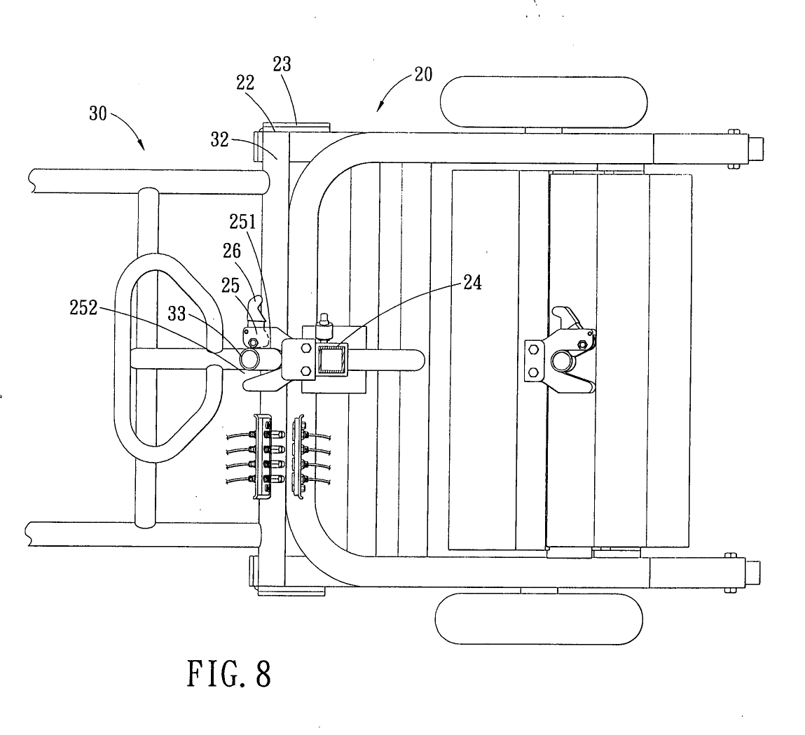

With reference to FIG. 6, to joint the front and the rear frames 30, 20 together, the user can position the cross bar 32 of the front frame 30 above the front edge 21 of the rear frame 20, then pushing the cross bar 32 downward so that both ends of the cross bar 32 will be guided by the guide plates 23 into the locking slot 22 of the rear frame 20. Consequently, the front and the rear frames 30, 20 are roughly positioned, as shown in FIG. 7. Referring further to FIGS. 7 and 8, by pushing the front frame 30 upward, the upright bar 33 will moves toward the locking portion 25 of the rear frame 20 and finally will be locked in the gap 251 of the locking portion 25, meanwhile, the upright bar 33 will also be locked by an end of the hook 26. thereby, the front and the rear frames 30, 20 are firmly jointed.

With reference to FIG. 8, to disconnect the front and the rear frames 30, 20, the user can turn the hook 26 so as to make the end of the hook 26 move away from the upright bar 33 of the front frame 30, and then pushing the upright bar 33 toward the mouth 252 of the gap 251 of the locking portion 25, so that the upright bar 33 is unlocked from the locking portion 25, as shown in FIG. 7. After that, with reference to FIG. 6, pulling the front frame 30 upward, the both ends of the cross bar 32 will disengage the locking slots 22 of the rear frame 20. Consequently, the front and the rear frames 30, 20 are disconnected.

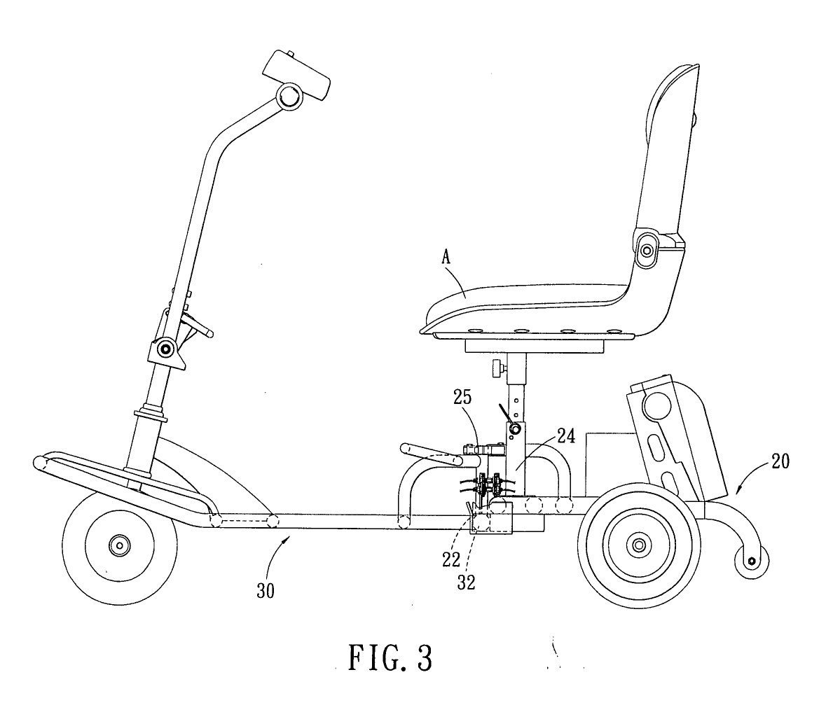

The present invention provides a quick connection and disconnection between the front frame 30 and the rear frame 20, especially when the front frame 30 and the rear frame 20 are connected, the cross bar 32 of the front frame 30 is locked in the slots 22 of the rear frame 20, meanwhile, the upright bar 33 of the front frame 30 is locked with the locking portions 25 of the rear frame 20. In this case, when the user sits on the seat A (as shown in FIG. 3), his or her body weight will press the cross bar 32 downward against the locking slots 22, thus making the upright bar 33 of the front frame 30 lock with the locking portion 25 of the rear frame 20 more firmly.

While we have shown and described various embodiments in accordance with the present invention, it should be clear to those skilled in the art that further embodiments may be made without departing from the scope of the present invention.

1. A quick-release mechanism for an electric cart comprising:
a rear frame, at both sides of a front edge of the rear frame being formed a locking slot, respectively, an upright column provided on the front edge of the rear frame and located between the locking slots, at an end of the upright column provided a locking portion, a gap formed on the locking portion, the locking portion further provided with a moveable hook an end of which being installed in the gap of the locking portion, and another end of the moveable hook located outside the gap of the locking portion;
a front frame provided at its rear edge with a cross bar, on the cross bar provided an upright bar, both ends of the cross bar locked in the locking slots at both sides of the rear frame, the upright bar locked in the gap of the locking portion by the hook.

2. The quick-release mechanism for an electric cart as claimed in claim 1, wherein a guide plate is slantwise disposed at an upper edge of the locking slot of the rear frame.

3. The quick-release mechanism for an electric cart as claimed in claim 1, wherein the gap of the locking portion of the rear frame faces the same direction as the front edge of the frame, so as to receive the upright bar of the front frame.
